(19) United States
(12) Patent Application Publication
(10) Pub. No.: US 2002/0092900 A1
(43) Pub. Date: Jul. 18, 2002

(54) Fiber drum, cylindrical body thereof, and method of fabricating the cylindrical body

(76) Inventor: Motoharu Kasuya, Wakayama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/761,189

(22) Filed: Jan. 18, 2001

(51) Int. Cl. B65D 3/10; B31B 1/74

(52) U.S. Cl. 229/5.5; 229/5.6; 493/158

(57) ABSTRACT

A cylindrical body of a fiber drum comprises a roll of a paper material having two opening ends; and a curled portion formed by inwardly curling the edge of at least one of said two opening ends. A method of fabricating said fiber drum comprises the steps of winding a length of paper sheet in layers, between which an adhesive is applied, to form a roll of the paper sheet having two opening ends, and inwardly curling the edge of at least one of said two opening ends of the roll to form a curled portion before the adhesive is cured between the layers.

### BACKGROUND OF THE INVENTION

1. Field of the Invention

The present invention relates to a fiber drum made mainly of a paper material, a cylindrical body of the paper material constituting the fiber drum, and a method of fabricating the cylindrical body.

2. Prior Art of the Invention

One of such conventional cylindrical bodies of fiber drum is illustrated in FIG. 13. The cylindrical body consists mainly of a roll B of a paper sheet S having a bottom at one end. The roll B has an opening C thereof at the other end and its edge is inwardly curled together with a metal ring E thus forming an inwardly curled rim F.

The metal ring E has an inward rib G at an intermediate thereof projected substantially 10 mm inwardly of the roll B.

As the cylindrical body A has the paper sheet S and the metal ring E curled together, its curled rim F will particularly require more labor and time to be disassembled in the recycling process. Also, the rim F has to be further separated into the metal ring E and the paper sheet S with extra labor. Once an amount of powder or grains is directly loaded into the fiber drum with no use of any inner bag, its portion may be trapped by the inward rib G and the inwardly curled rim F of the cylindrical body A and fail to be removed out from the drum.

We, the inventors, have proposed a modified fiber drum disclosed in Japanese Patent Laid-open Publication 2000-185724 as shown in FIG. 14. A cylindrical body A2 of the fiber drum shown in FIG. 14 comprises a roll B2 having a cylindrical shape and made of simply a paper material with an adhesive. The roll B2 in its vertical position has outwardly curled portions I and J provided on both, upper and lower, ends thereof at openings. The cylindrical body A2 is accompanied with a cover plate K and a bottom plate L both made of a paper material, hence constituting the fiber drum D. The cover plate K consists mainly of a top portion M of a disk shape and a rim portion N extending perpendicularly from the top portion M for detachably joining to the upper curled portion I of the cylindrical body A2. The bottom plate L consists mainly of a bottom portion O of a disk shape and a rim portion P extending perpendicularly from the bottom portion O and bonded by an adhesive to the lower curled portion J. The drum is filled with desired objects and then sealed off at the joint between the rim portion N of the cover plate K and the roll B2 with a length of sealing tape (not shown). Accordingly, the fiber drum D using no metal material can easily be disassembled. Also, as the cylindrical body A2 has no projection on its inner side, it can allow the content such as powder to be completely removed out with no residue.

However, the body B2 of the fiber drum D shown in FIG. 14 has its inner side turned over the outer side for forming the curled portions I and J. As the material of the inner side is pulled radially of the opening at each end, the curled portion I or J may have a flaw. The flaw will then result in the generation of paper dusts. For compensation, the curled portions I and J after formed are often coated at their surfaces with a resin material or the like. This will claim extra labor and cost.

### SUMMARY OF THE INVENTION

The present invention has been developed in view of the foregoing aspects and its object is to provide a fiber drum, a cylindrical body thereof, and a method of fabricating the cylindrical body where the physical strength at each opening end of the cylindrical body is substantially high, the content can be loaded and unloaded without difficulty, the separation of a paper material from the others is not needed, and the injury during the forming or processing is minimized.

For achievement of the object, a cylindrical body of a fiber drum according to the present invention comprises a roll of a paper material having at one opening end and/or the other opening end a curled portion thereof formed by inwardly curling the edge of the one opening end and/or the other opening end. As the curled portion is made of the same material as of the roll, the physical strength will be increased at about the one opening end or the other opening end. As no metal material is used, the separation of the paper material from metals is unnecessary at the disposal.

A method of fabricating a cylindrical body of a fiber drum according to the present invention is provided comprising the steps of winding a length of paper sheet in layers, between which an adhesive is applied, to form a roll of the paper sheet, and inwardly curling the edge of one opening end and/or the other opening end of the roll to form a curled portion before the adhesive is cured between the layers. As the step of forming the curled portion takes a short duration of time, the fabrication of the cylindrical body will be increased in the efficiency hence permitting the mass production.

Alternatively, the method of fabricating a cylindrical body of a fiber drum is modified in which the curled portion formed by inwardly curling the edge of one opening end and/or the other opening end of the roll is then pressed down. As the curled portion is inwardly curled, its pressing process will hardly develop flaws on the curled portion as compared with an outwardly curled portion of the prior art.

A fiber drum according to the present invention is provided comprising a cylindrical body having a couple of curled portions provided at one opening end and the other opening end of a roll of a paper material thereof by inwardly curling the edges of the one opening end and the other opening end of the same, a cover plate made of a paper material detachably joined to the curled portion at the one opening end to shut up one opening of the roll of the cylindrical body, and a bottom plate made of a paper material fixedly joined to the curled portion at the other opening end to shut up the other opening of the roll of the cylindrical body. As the cylindrical body, the cover plate, and the bottom plate all are made of the paper material, the separation of the paper material from other metal materials will be unnecessary at the disposal of the fiber drum.

Another fiber drum according to the present invention is provided comprising a cylindrical body having a curled portion provided at one opening end of a roll of a paper material thereof by inwardly curling the edge of the one opening end of the same, a cover plate made of a paper material detachably joined to the one opening end to shut up one opening of the roll of the cylindrical body, and a bottom plate made of a paper material fixedly joined to the other opening end to shut up the other opening of the roll of the cylindrical body, wherein the edge of the other opening end of the roll is inwardly curled together with the circumferential edge of the bottom plate to fixedly join between the other opening end of the roll and the bottom plate. The cylindrical body and the bottom plate are inwardly curled at once, hence eliminating a sequence of the steps of forming the cylindrical body and the bottom plate separately and bonding them together. As the overall number of steps of the method is decreased, the cost down will be guaranteed. Also, the inner side of the cylindrical body has no projection adjacent to the bottom plate, hence allowing the content to be readily discharged without being trapped as compared with the conventional body having an inner rib and to be free from any residue.

### BRIEF DESCRIPTION OF THE DRAWINGS

FIG. 1 is an external view of the cylindrical body of a fiber drum according to one embodiment of the present invention;

FIG. 2 is a partially cross sectional front view of the cylindrical body;

FIG. 3 is an external view of the fiber drum according to the embodiment of the present invention;

FIG. 4 is an explanatory view illustrating a step of fabricating a green form of the cylindrical body;

FIG. 5 is a front view of a forming machine for forming a curled potion on one opening end of the green form of the cylindrical body;

FIG. 6 is a cross sectional front view illustrating a step of forming the curled portion on the one opening end of the green form which is placed on the forming machine;

FIG. 7 is an enlarged cross sectional view illustrating the step of forming the curled portion on the one opening end of the green form;

FIG. 8 is a cross sectional front view illustrating the step of forming the curled portion on the one opening end of the green form where the curled portion is dislocated outwardly by the action of a forming die;

FIG. 9 is a cross sectional front view illustrating a step of forming the curled portion on the one opening end of the green form where the dislocated curled portion is pressed down with a chuck;

FIG. 10 is a cross sectional front view showing partially the bottom of a cylindrical body of a fiber drum according to another embodiment of the present invention;

FIG. 11 is a cross sectional front view showing partially a modification of the bottom of the fiber drum;

FIG. 12 is a cross sectional front view showing partially another modification of the bottom of the fiber drum;

FIG. 13 is an explanatory view showing a step of removing powder from one opening of a conventional fiber drum tilted; and

FIG. 14 is a partially cross sectional front view of another conventional fiber drum.

### DETAILED DESCRIPTION OF THE PREFERRED EMBODIMENTS

A first embodiment of the present invention will be described in more detail referring to the relevant drawings.

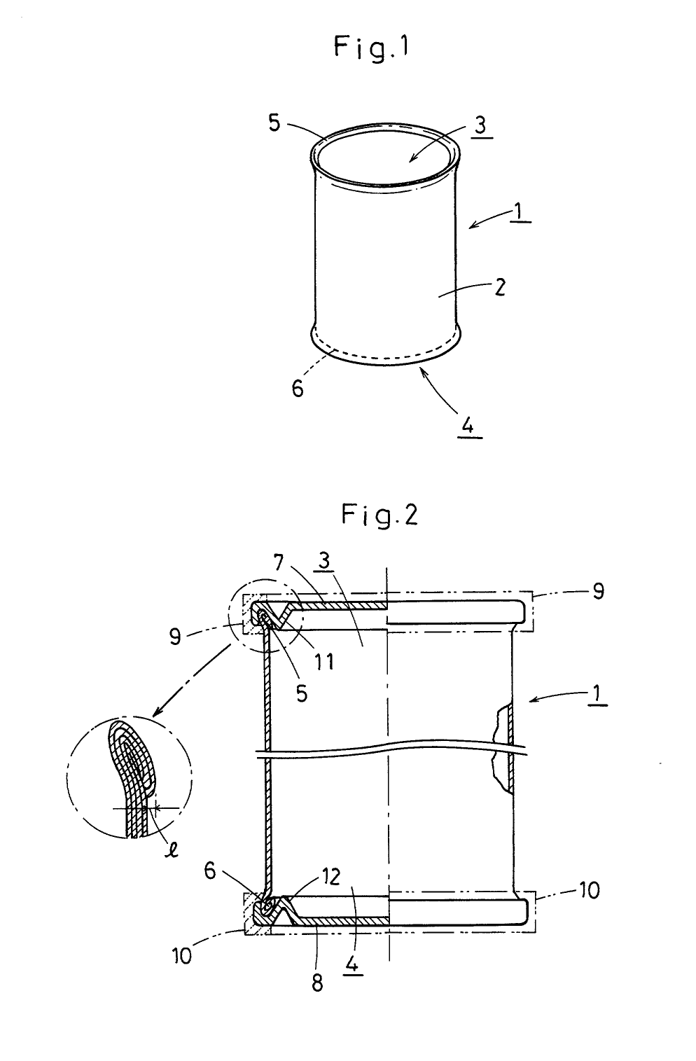

FIG. 1 is an external view showing a cylindrical body of a fiber drum of the embodiment. FIG. 2 is a partially cross sectional front view of the cylindrical body.

As shown, the cylindrical body 1 of the fiber drum consists mainly of a roll 2 of a paper material with an adhesive The roll 2 may be made of a plurality of paper sheets or a single sheet of paper which is rolled as will be explained later.

The roll 2 in its vertical position has an opening 3 thereof provided at the upper end and an opening 4 at the other end. The roll 2 has an upper edge curled inwardly at the one opening 3 forming a curled portion 5 which is oval in the cross section and annular in the plan view as continuous along the circumference. The curled portion 5 is tilted outwardly and radially of the roll 2. The oval cross section of the curled portion 5 is so tightly pressed as to eliminate the hollow space and its thickness is substantially 1 mm greater than the thickness of the roll 2. The lower edge at the other opening 4 of the roll 2 also is inwardly curled to form a curled portion 6 which is identical in the size to the curled portion 5.

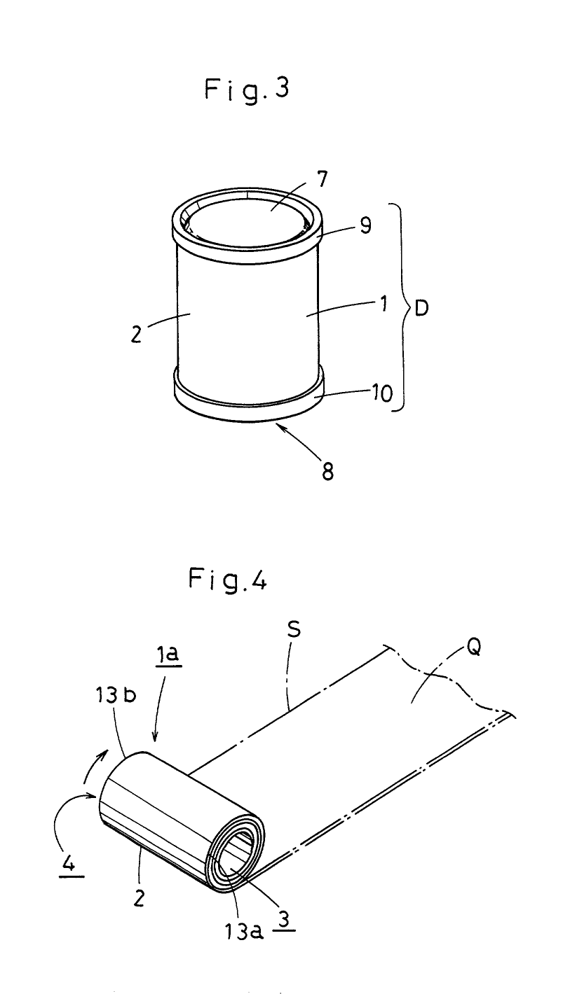

The cylindrical body 1 having the above arrangement is accompanied, as shown in FIGS. 2 and 3, with a cover plate 7 and a bottom plate 8 both made of a paper material, thus constituting the fiber drum D. The cover plate 7 and the bottom plate 8 are arranged of a disk shape and reinforced at outer edge with reinforce ribs 11 and 12 respectively which are annular in the plan view. The cover plate 7 and the bottom plate 8 are detachably mounted to the corresponding curled portions 5 and 6 at the one opening 3 and the other opening 4 respectively. The joints between the cover plate 7 and the curled portion 5 and between the bottom plate 8 and the curled portion 6 are covered with a couple of tightening bands 9 and 10 respectively to seal off the fiber drum D.

The fiber drum D comprises the cylindrical body 1, the cover plate 7, and the bottom plate 8 made of the paper material, employing no metal. Accordingly, when is out of use and discarded, the fiber drum D requires no traditional separation into paper and metal. As the curled portions 5 and 6 are inwardly curled, they develop no tension towards the radial direction and will be prevented from generation of flaws as compared with the outwardly curled portions. The curled portions 5 and 6 are tilted radially and outwardly of the cylindrical body 2 and can thus be joined to the cover plate 7 and the bottom plate 8 more closely while being covered with their respective tightening bands 9 and 10. This eliminates the need of specific seals or packings. While the curled portions 5 and 6 of the cylindrical body 1 according to the present invention are rigid enough without being pressed down, their pressed-down structure having no hollow space will contribute to the higher physical strength of the cylindrical body 1. Moreover, because the difference between the curled portions 5 and 6 and the other portion of the cylindrical body 1 is as small as 1 mm, the inner side of the cylindrical body 1 may be less undulated. Accordingly, any content such as powder can successfully be removed out from the fiber drum D without being trapped.

The present invention is not limited to the embodiment with the tightening bands provided about the one opening 3 and the other opening 4 for sealing off. For shutting up the other opening 4 of the cylindrical body 1, the curled portion 6 may be bonded by an adhesive to a bottom member 80 which comprises a bottom portion 81 and a flange portion 82 extending from the edge of the bottom portion 81 as shown in FIG. 11. Similarly, the one opening 3 of the cylindrical body 1 may be shut off with a cover member (not shown), which comprises a cover portion and a flange portion extending from the edge of the cover portion, bonded to the curled portion 5 by an adhesive.

A method of fabricating the cylindrical body 1 will now be described.

The method starts with a step of forming a green cylindrical body la as shown in FIG. 4. More specifically, a length of paper sheet S coated at its upper side with an adhesive Q before curing is wound in seven to eight layers on the mandrel of a drum forming machine (not shown) to form a roll 2 of the green cylindrical body 1a. The adhesive Q may be any commercially available hydrophilic adhesive composed mainly of e.g. poly-vinyl acetate emulsion or poly-vinyl alcohol.

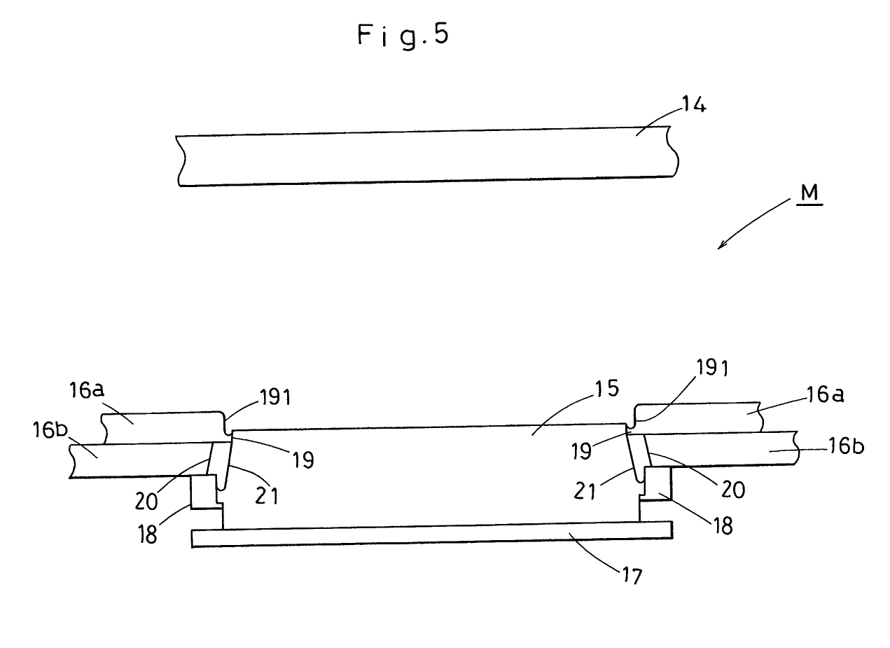

The green cylindrical body la is then transferred to a curled portion forming step which may be carried out by a forming machine M shown in FIG. 5. The forming machine M performs a sequence of three steps, (1) the first step of inwardly curling both edges 13a and 13b of the green cylindrical body 1a, (2) the second step of increasing the cross section of each curled portion radially and outwardly, and (3) the third step of pressing down the curled portions.

The forming machine M has a forming die 15 of substantially a circular shape in the plan view placed on a platform 17 supported by the floor bed and fixedly held at an intermediate of its outer side with an annular chuck support 18. A first chuck 16a and a second chuck 16b which travel forward and backward on the horizontal are provided on the upper side of the chuck support 18. The first chuck 16a located upper has a guide region 19 provided on the inner wall thereof for inwardly curling the edge of the roll with its guiding surface 191. The first chuck 16a is at the inner wall below the guide region 19 in direct contact with the outer side of the forming die 15. The inner wall of the second chuck 16b located lower is a taper surface 20 which is tilted to increase the opening towards the lower end and opposite to a taper surface 21 of the outer side of the forming die 15 tilted at the same angle. A vertically movable pressing member 14 is provided precisely above the forming die 15 for pressing down the green cylindrical body against the forming die 15.

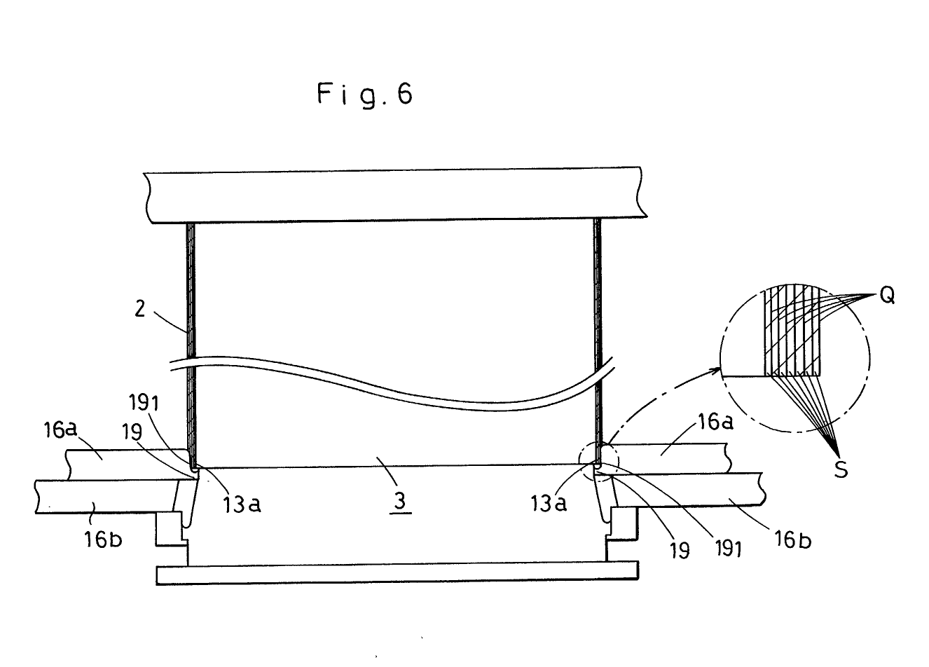

In action, the roll 2 of the layers of the paper sheet S before the adhesive Q is cured is loaded and placed upright on the guide region 19 of the first chuck 16a so that its edge 13a at the one opening 3 sits directly on the guide region 19, as shown in FIG. 6. While FIG. 6 illustrates the edge at the one opening 3 for simplicity of the description, the edge at the other opening 4 of the roll 2 can also be shaped after turned up side down.

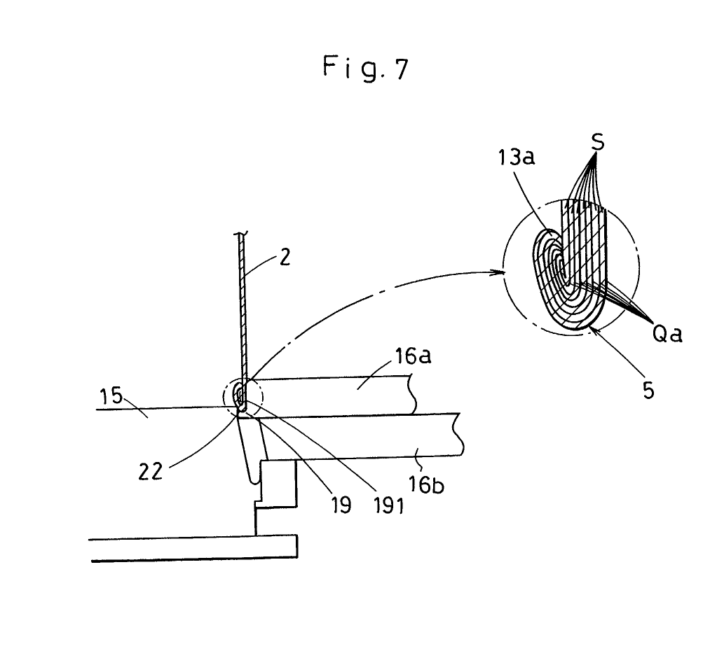

As the pressing member 14 is then lifted down, the edge 13a of the roll 2 is pressed down between the guiding surface 191 of the guide portion 19 and the outer side 22 of the forming die 15 to turn to an inwardly curled portion shown in FIG. 7.

When pressed down, the inner layers of the paper sheet S of the green cylindrical body 1a lag behind the outer layers due to a difference in the curvature radius at the curled portion 5 or 6. The layers of the paper sheet S when curled are not separated but remain bonded to each other by the action of the adhesive Q. Also, the adhesive serves as a lubricant to assist the lagging. Simultaneously, as the layers of the paper sheet S are curled, portions of the adhesive Q between the layers of the edge 13a of the green cylindrical body la are squeezed out hence running over the inner side of the roll 2. As a result, the portions of the adhesive Q may contribute to the higher adhesivity and when cured, the improved rigidity of the curled portions 5 and 6.

By the above manner, the curled portions 5 and 6 of the roll 2 are formed at the one opening 3 and the other opening 4 respectively. As known, the curled portions 5 and 6 are instantly formed in a sequence. Then, as the adhesive Q is cured between the layers of the paper sheet thus to turn to an adhesive Qa, the curled portions 5 and 6 are increased in the rigidity.

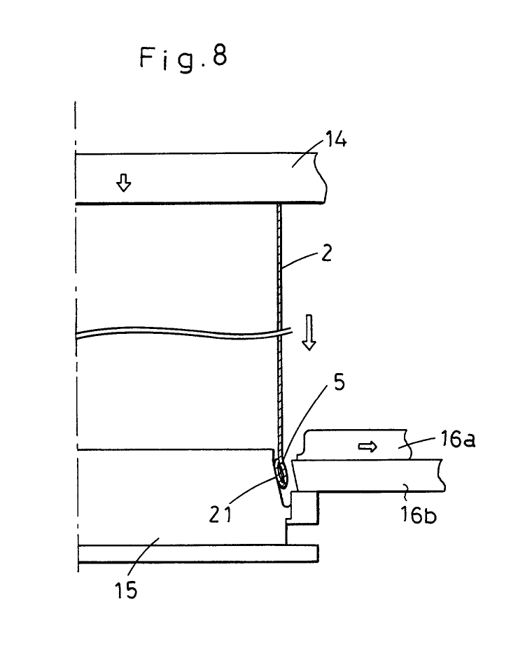

This is followed by retracting the first chuck 16a from the curled portion 5 and 4 and lifting down the pressing member 14 further as shown in FIG. 8. As moved along the taper surface 21 of the outer side of the forming die 15, the curled portion 5 is turned outwardly. If the tilting angle is too large, the curled portion 5 may have flaws extending radially. When the tilting angle is too small, the effect of a tightening band or the like will be declined. It is hence essential to determine an appropriate angle of the tilting for ensuring the effect of the tightening band and eliminating the generation of flaws.

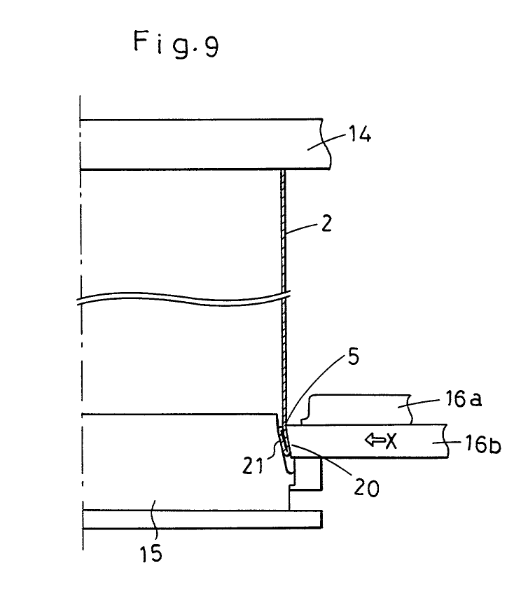

As shown in FIG. 9, the tilted curled portion 5 is held directly with the taper surface 21 of the forming die 15 and then the second chuck 16b is advanced in the direction X denoted by the arrow in FIG. 9 to press down the curled portion 5. Any hollow space in the curled portion 5 may decline the physical strength at the opening of the roll 2. The pressing down of the curled portion 5 may require a pressing force of 30 tons. The cylindrical body 1a of this embodiment is rigid enough and its physical strength may be increased by pressing down the curled portions 5 and 6 to eliminate any hollow space.

As explained above, the three steps for forming, tilting, and pressing the curled portions 5 and 6 are carried out in the single forming machine M which thus contributes to the down sizing and the simpler arrangement of the fabricating system.

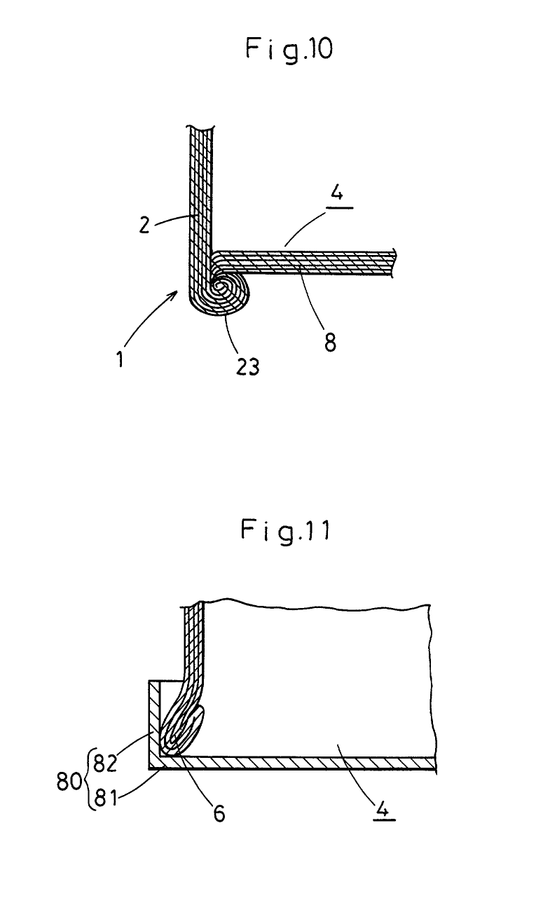

The present invention is not limited to the curled portions 5 and 6 provided on the edges at the openings 3 and 4 of the roll 2 but may be implemented with a curled portion 23 formed by inwardly curling the edge at the bottom opening 4 of the roll 2 together with the edge of the disk bottom plate 8 made of the same paper material thus to constitute the cylindrical body 1 of a fiber drum D2 as shown in FIG. 10. Similar to the first embodiment, the curled portion 23 is also pressed down to eliminate any hollow space. This embodiment is identical in the other arrangement to the first embodiment.

As the roll 2 and the bottom plate 8 are inwardly curled at their edges at one time, the method of fabricating the fiber drum D2 can significantly be simplified and thus favorable for mass production, decreasing the production cost. The curled portion 23 is pressed down and its physical strength will be increased to a desired level thus eliminating the need of extra reinforcement members of a metal material. This requires no separation into the paper material and the metal material at the disposal. Also, the cylindrical body 1 has no projection on the inner side thereof and thus allows any powder of the content to be readily removed out without being trapped.

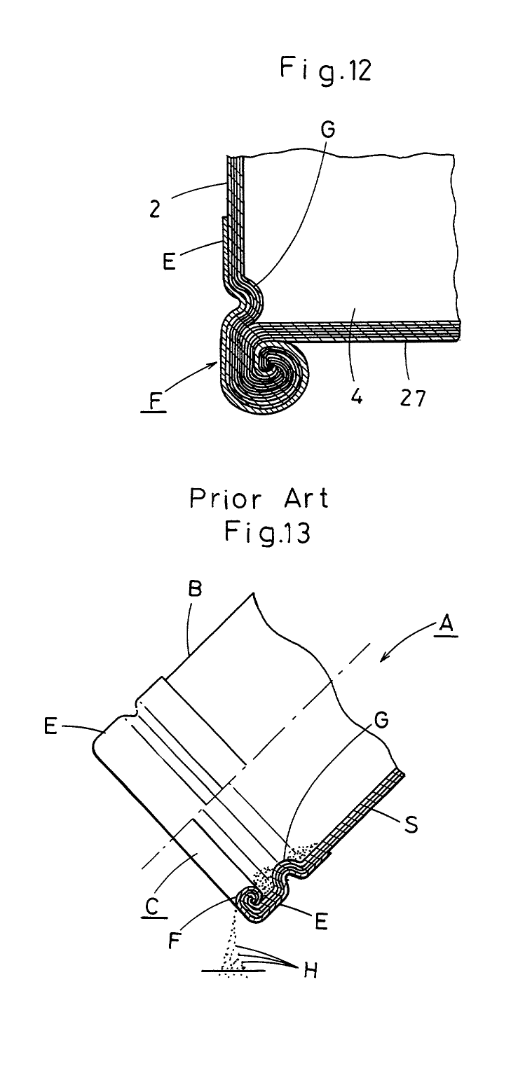

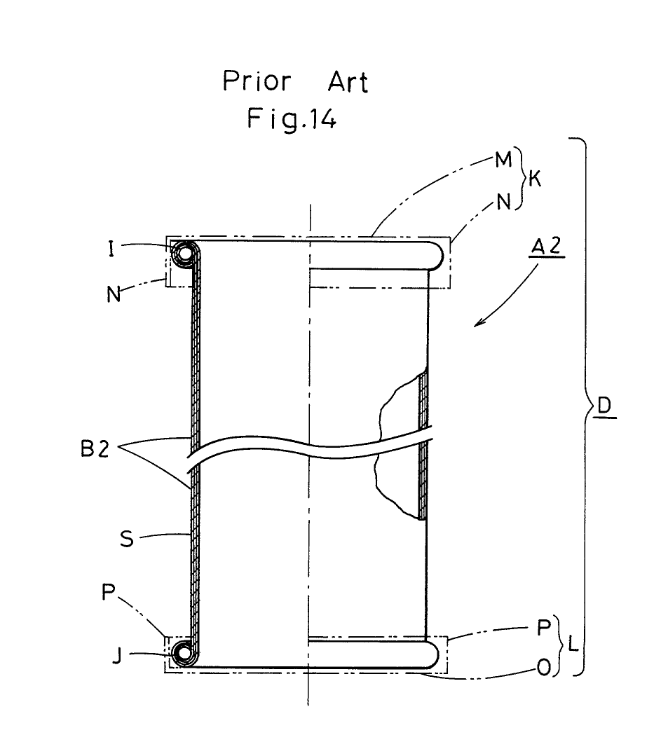

Alternatively, the curled portion 5 at the opening 3 may be replaced by a curled portion F formed by inwardly curling the edge at the bottom opening 4 of a roll 2 together with a metal ring E and a bottom plate 27 of the same paper material as shown in FIG. 12. More particularly, the edge of the bottom plate 27 is sandwiched between the edge and an inward rib G of the roll 2.

In this embodiment, no metal is used at the upper opening 3 of the roll 2. Accordingly, the separation of a fiber drum into the paper material and the metal material is less troublesome than that of the conventional fiber drum having metal materials at both ends. This embodiment will contribute to the reduction of the industrial waste.

The cover plate 7 and the bottom plate 8 of each fiber drum are not limited to the paper material but may be made of synthetic resin, metal, veneer plywood, or any other appropriate material.

It is also a good idea that when the adhesive A is about cured before the curled portions 5 and 6 are completely shaped, the body is heated up for softening the adhesive A between the layers of its paper sheet. If the adhesive A is of a hot melting type, it has to be heated to higher than its melting point.

What is claimed is:

1. A cylindrical body of a fiber drum comprising:
a roll of a paper material having two opening ends; and
a curled portion formed by inwardly curling the edge of at least one of said two opening ends.

2. A method of fabricating a cylindrical body of a fiber drum comprising the steps of winding a length of paper sheet in layers, between which an adhesive is applied, to form a roll of the paper sheet having two opening ends, and inwardly curling the edge of at least one of said two opening ends of the roll to form a curled portion before the adhesive is cured between the layers.

3. A method of fabricating a cylindrical body of a fiber drum according to claim 2, wherein the curled portion is then pressed down.

4. A fiber drum comprising a cylindrical body having a couple of curled portions provided at one opening end and the other opening end of a roll of a paper material thereof by inwardly curling the edges of the one opening end and the other opening end of the same, a cover plate made of a paper material detachably joined to the curled portion at the one opening end to shut up one opening of the roll of the cylindrical body, and a bottom plate made of a paper material fixedly joined to the curled portion at the other opening end to shut up the other opening of the roll of the cylindrical body.

5. A fiber drum comprising a cylindrical body having a curled portion provided at one opening end of a roll of a paper material thereof by inwardly curling the edge of the one opening end of the same, a cover plate made of a paper material detachably joined to the one opening end to shut up one opening of the roll of the cylindrical body, and a bottom plate made of a paper material fixedly joined to the other opening end to shut up the other opening of the roll of the cylindrical body, wherein the edge of the other opening end of the roll is inwardly curled together with the circumferential edge of the bottom plate to fixedly join between the other opening end of the roll and the bottom plate.
